(19) United States
(12) Patent Application Publication
(10) Pub. No.: US 2011/0096223 A1
(43) Pub. Date: Apr. 28, 2011

(54) CAMERA MODULE AND MANUFACTURING METHOD THEREOF

(75) Inventor: CHING-YAO FU, Tu-Cheng (TW)

(73) Assignee: HON HAI PRECISION INDUSTRY CO., LTD., Tu-Cheng (TW)

(21) Appl. No.: 12/650,764

(22) Filed: Dec. 31, 2009

(30) Foreign Application Priority Data
Oct. 22, 2009 (CN) 200910110313.1

(51) Int. Cl. H04N 5/225; B21D 39/00

(52) U.S. Cl. 348/374; 29/592.1; 348/E05.024

(57) ABSTRACT

A camera module includes an image sensor, a first substrate, a lens, a second substrate, and a light shading cover. The first substrate includes a first surface and a second surface opposite to the first surface. The first substrate defines a first aperture. The image sensor is attached to the first surface. The lens is attached to the second surface. The second substrate is attached to a surface of the lens away from the first substrate. The second substrate defines a second aperture. The light shading cover defines a third aperture. The light shading cover is covered on the second substrate and defining a third aperture coaxial to the first aperture . The center of the first aperture, the second aperture, and the third aperture are located on the optical axis of the camera module.

### BACKGROUND

1. Technical Field

The present disclosure relates to camera modules, and particularly, to a compact camera module and method for manufacturing same.

2. Description of Related Art

Camera modules are currently used in a variety of portable electronic devices. such as mobile phones, PDAs (personal digital assistants) and computers.

A camera module often includes a lens module and an image sensor chip received in the lens module. The lens module includes a barrel, a holder, and a lens received in the barrel. The barrel is threaded in the holder. However, because each camera module is manufactured by assembling the lens, the image sensor chip, the barrel, and the holder together, the process of assembling a plurality of camera modules is very time-consuming.

What is needed, therefore, is a camera module and a method for manufacturing same to overcome the described limitations.

### BRIEF DESCRIPTION OF THE DRAWINGS

Many aspects of the present camera module and method for manufacturing same can be better understood with reference to the following drawings. The components in the drawings are not necessarily drawn to scale, the emphasis instead being placed upon clearly illustrating the principles of the camera module and method for manufacturing same.

FIG. 1 is a cross-section of a camera module according to an exemplary embodiment.

FIGS. 2 to 3 are cross-sections of a manufacturing method for a camera module.

### DETAILED DESCRIPTION

Embodiments of the present disclosure will now be described in detail below, with reference to the accompanying drawings.

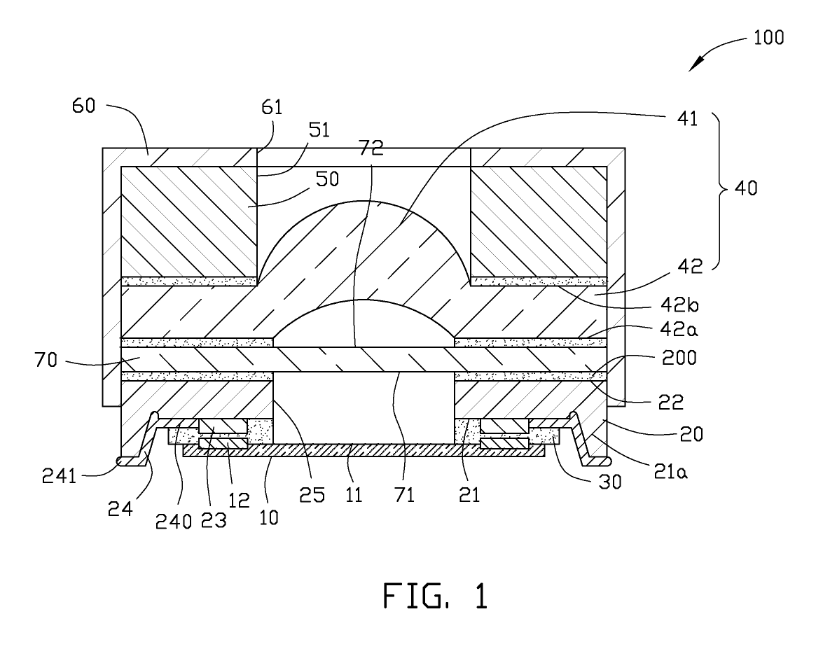

Referring to FIG. 1, a camera module 100, according to an exemplary embodiment, is shown. The camera module 100 includes an image sensor 10, a first substrate 20, a lens 40, a second substrate 50, a light shading element 60, and an infrared filter 70. The second substrate 50, the lens 40, the infrared filter 70, the first substrate 20, and the image sensor 10 are arranged in order from the object side to the image side of the camera module 100.

The image sensor 10 includes a sensing area 11 and a number of chip pads 12 arrayed around the sensing area 11. In the present embodiment, the sensing area 11 is located at the center of the image sensor 10. The sensing area 11 is rectangular.

The first substrate 20 includes a first surface 21, a second surface 22 opposite to the first surface 21, a number of substrate pads 23, and a number of leads 24. A first aperture 25 is defined on the first substrate 20. The first aperture 25 passes through the first surface 21 and the second surface 22. In the present embodiment, the first aperture 25 is located at the center of the first substrate 20. The first substrate 20 can be made from opaque plastic or semiconductor. In the present embodiment, the first substrate 20 is made from opaque high-temperature resistant organic material. The first surface 21 of the first substrate 20 is closed to the image sensor 10. An annular protrusion 21a extends from the first surface 21 away from the second surface 22. The number of the substrate pads 23, and the number of the leads 24 are same as the number of the chip pads 12. The substrate pads 23 are located on the first surface 21 corresponding to the chip pads 12. The leads 24 are located on the first surface 21 corresponding to the substrate pads 23. Each lead 24 includes a first linking end 240 and a second linking end 241. The first linking end 240 is electrically connected to the substrate pad 23. The second linking end 241 is fixed on an end surface of the annular protrusion 21a away from the first substrate 20 for connecting to a circuit board (not shown).

Each substrate pad 23 is electrically connected to the corresponding chip pad 12 via an adhesive 30, such as an anisotropic conductive adhesive. The sensing area 11 is surrounded by the adhesive 30.

The infrared filter 70 is covered on the first substrate 20 via glue 200. The infrared filter 70 includes a third surface 71 and a fourth surface 72 opposite to the third surface 71. The third surface 71 abuts the second surface 22. In other embodiments, the infrared filter 70 can alternatively be hot pressed on the second surface 22 of the first substrate 20.

The lens 40 is located on the infrared filter 70 via glue 200. The lens 40 includes an optical portion 41 formed at the center thereof and a holding portion 42 surrounding the optical portion 41. The holding portion 42 includes a first resisting surface 42a and a second resisting surface 42b opposite to the first resisting surface 42a. The first resisting surface 42a abuts the fourth surface 72. The optical portion 41 is substantially aligned with the first aperture 25.

The second substrate 50 is located on the second resisting surface 42b of the holding portion 42 via glue 200. The second substrate 50 is made from the same material as the first substrate 20. A second aperture 51 is defined on the second substrate 50. The second aperture 51 is substantially aligned with the optical portion 41 of the lens 40. Furthermore, the second substrate 50 can, alternatively, be hot pressed on the second resisting surface 42b.

The light shading element 60 is located on the upper portion of the second substrate 50. A third aperture 61 is defined at the center of the light shading element 60. The light shading element 60 is deposited at the object side of the camera module 100. In the present embodiment, the light shading element 60 is a light shading cover. The light shading element 60 can, alternatively, be an opaque film. In the present embodiment, the center of the first aperture 25, the second aperture 51, the third aperture 61, and the sensing area 11 are coaxial to the optical axis of the camera module 100. Because the camera module is mounted without a holder and a barrel, with a number of thin substrates, the camera module is easily assembled, and the size of the camera module can be more compact.

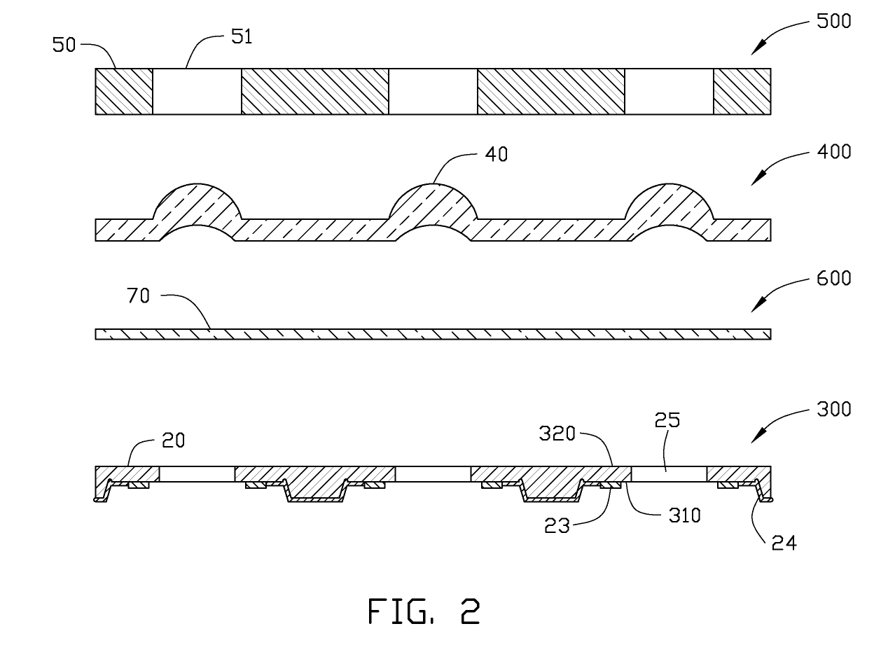

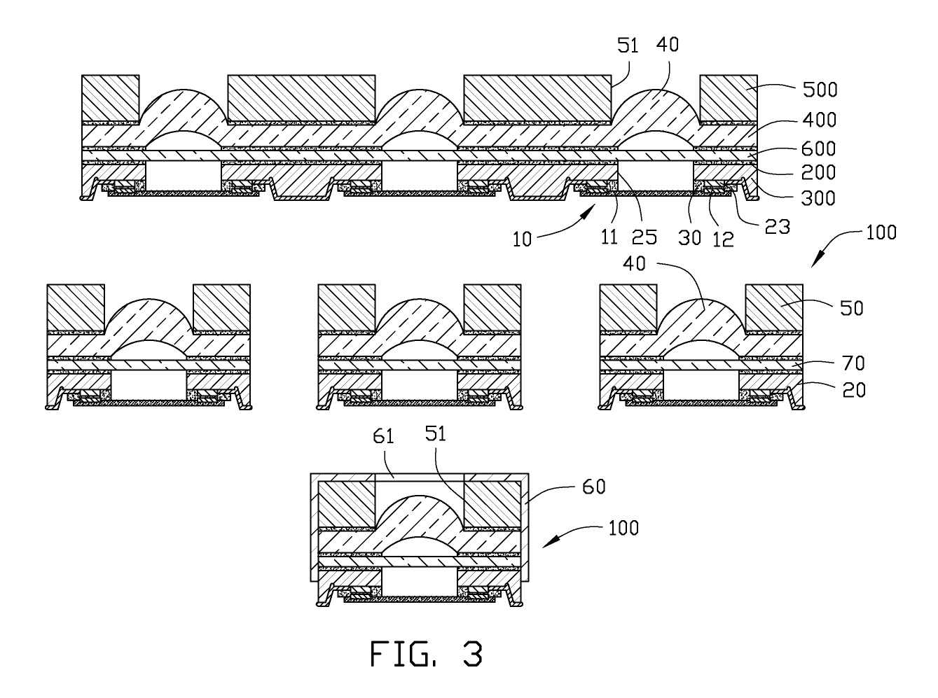

Referring to FIGS. 2, and 3, one embodiment of a manufacturing method for a camera module 100 is shown. The method follows.

A first board 300 such as one shown in FIG. 2 is provided. The first board 300 includes a first board surface 310 and a second board surface 320 opposite to the first board surface 310. The first board 300 can be opaque plastic or semiconductor material. In the present embodiment, the first board 300 is an opaque high-temperature resistant organic material. A number of first apertures 25 are defined on the first board 300. A number of substrate pads 23 are formed on the first board surface 310. Each first aperture 25 is surrounded by a group of substrate pads 23. In the present embodiment, a number of leads 24 are attached on the first board surface 310 to electrically connect to the corresponding substrate pad 23. The first board 300 can be manufactured by hot press forming process or an injecting molding process. In the present embodiment, the first board 300 is manufactured by a hot press forming process.

A fourth board 600 is Attached onto the second board surface 320 of the first board 300 via glue 200. The fourth board 600 includes a number of infrared filters 70. In the present embodiment, the fourth board 600 is a glass board coated with infrared cut coating.

A second board 400 is attached onto the fourth board 600 by glue 200. The second board 400 includes a number of lenses 40 corresponding to the first apertures 25. The second board 400 can be manufactured by hot press forming or injecting molding. In the present embodiment, the second board 400 is manufactured by hot press forming. The lens 40 is aligned with the corresponding first aperture 25 of the first board 300.

A third board 500 is attached onto the second board 400. The third board 500 is the same material as the first board 300. The third board 500 defines a number of second apertures 51 corresponding to the first apertures 25 of the first board 300. In the present embodiment, the third board 500 is attached to a surface of the second board 400 away from the first board 300 using glue 200. The second apertures 51 is aligned with the lens 40 on the second board 400.

A number of image sensors 10 are attached onto the first board 300. Each image sensor 10 includes a sensing area 11 and a number of chip pads 12 arrayed around the sensing area 11. In the present embodiment, the sensing area 11 is located at the center of the image sensor 10. The sensing area 11 is rectangular. Each sensing area 11 of the image sensor 10 is aligned with the first aperture 25 of the first board 300. Each chip pad 12 is electrically connected to the corresponding substrate pad 23 via adhesive 30. The sensing area 11 is surrounded by the adhesive 30.

The first board 300, the second board 400, the third board 500, and the fourth board 600 are cut to form a number of camera modules 100 Each camera module 100 includes first substrate 20, infrared filter 70, lens 40, and second substrate 20.

A light shading element 60 is disposed at the object side of the camera module 100. Each light shading element 60 includes a third aperture 61 disposed at the center thereof. In the present embodiment, the light shading element 60 is a light shading cover. The center of the first aperture 25, the second aperture 51, the third aperture 61, and the sensing area 11 are located on the optical axis of the camera module 100.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A camera module, comprising:
a first substrate comprising a first surface and a second surface opposite to the first surface, the first substrate defining a first aperture, the center of the first aperture located on an optical axis of the camera module;
an image sensor attached to the first surface and the image sensor coaxial to the first aperture;
a lens attached to the second surface of the first substrate;
a second substrate attached to a surface of the lens away from the first substrate, the second substrate defining a second aperture coaxial to the first aperture;
a light shading element covered on the second substrate and defining a third aperture coaxial to the first aperture.

2. The camera module as claimed in claim 1, wherein the first substrate and the second substrate are opaque material.

3. The camera module as claimed in claim 1, wherein a plurality of substrate pads are disposed on the first surface, the first aperture is surrounded by the plurality of substrate pads, the image sensor comprises a sensing area and a plurality of chip pads around the sensing area to electrically connected to the corresponding substrate pad.

4. The camera module as claimed in claim 1, wherein the image sensor is attached onto the first surface via an anisotropic conductive adhesive.

5. The camera module as claimed in claim 1, wherein the camera module further comprises a filter disposed between the lens and the first substrate.

6. The camera module as claimed in claim 5, wherein the filter is an infrared filter.

7. The camera module as claimed in claim 3, wherein an annular protrusion extends from the first surface of the first substrate away from the second surface.

8. The camera module as claimed in claim 7, wherein a plurality of leads is located on the first surface of the first substrate corresponding to the substrate pads, each lead comprises a first linking end electrically connected to the corresponding substrate pad and a second linking end fixed on an end surface of the annular protrusion away from the first substrate.

9. A manufacturing method of a camera module, comprising:
providing a first board comprising a first board surface and a second board surface opposite to the first board surface, and the first board defining a plurality of first apertures;
attaching a second board onto the second board surface of the first board, and the second board comprising a plurality of lenses with respect to the first apertures defined on the first board;
attaching a third board onto a surface of the second board away from the first board, the third board defining a plurality of second apertures with respect to the first apertures of the first substrate;
attaching a plurality of image sensors onto the first board surface of the first board, each image sensor coaxial to one first aperture;
cutting the first board, the second board, and the third board to form a plurality of camera modules;
disposing a light shading element at the object side of the camera module, each light shading element defining a third aperture coaxial to the second aperture.

10. The manufacturing method for a camera module as claimed in claim 9, wherein the first aperture of the first board is surrounded by a plurality of substrate pads.

11. The manufacturing method for a camera module as claimed in claim 10, wherein each image sensor comprises a sensing area and a plurality of chip pads around the sensing area, each chip pad is electrically connected to the corresponding one substrate pad.

12. The manufacturing method for a camera module as claimed in claim 9, further comprising disposing a fourth board between the first board and the second board, the fourth board comprising a plurality of filters with respect to the lens on the second board.

13. The manufacturing method for a camera module as claimed in claim 12, wherein the fourth board is a glass board coated with infrared cut coating.

14. The manufacturing method for a camera module as claimed in claim 9, wherein the first board and the second board are opaque material.

15. The manufacturing method for a camera module as claimed in claim 9, wherein a plurality of substrate pads are disposed on the first board surface, the first aperture is surrounded by the substrate pads, the image sensor comprises a sensing area and a plurality of chip pads around the sensing area, and each chip pad is electrically connected to the corresponding substrate pad.

16. The manufacturing method for a camera module as claimed in claim 9, wherein the image sensor is attached to the first board surface by anisotropic conductive adhesive.
